(19) United States
(12) Patent Application Publication
(10) Pub. No.: US 2017/0127647 A1
(43) Pub. Date: May 11, 2017

(54) METHOD AND APPARATUS FOR STIMULATING FOOD INTAKE IN DOMESTICATED ANIMALS

(71) Applicant: Joe J. Owens, III, Henderson, NV (US)

(72) Inventor: Joe J. Owens, III, Henderson, NV (US)

(21) Appl. No.: 15/244,451

(22) Filed: Aug. 23, 2016

Related U.S. Application Data
(60) Provisional application No. 62/252,650, filed on Nov. 9, 2015.

(51) Int. Cl. A01K 5/01

(52) U.S. Cl. CPC A01K 5/0114

(57) ABSTRACT

A food bowl system may include a first bowl having a side wall and a perforated member. A second bowl having a bottom portion and a sidewall is releasably engageable with the first bowl so that the first and second bowls can be separated and joined together with the perforated member disposed therebetween. Aromas from an aroma-producing material placed in the second bowl migrate through the perforated member and into the first bowl stimulating an animal to consume animal food provided in the first bowl.

### CROSS-REFERENCE TO RELATED APPLICATION

This application claims the benefit of U.S. Provisional Patent Application No. 62/252,650, filed on Nov. 9, 2015, which is hereby incorporated herein by reference for all that it discloses.

### TECHNICAL FIELD

The present invention relates to methods and apparatus for stimulating food intake in domesticated animals and more particularly to methods and apparatus that stimulate an animal's appetite by targeting the animal's olfactory bulb with a food aroma in such a way that the animal is enticed to eat the desired food.

### BACKGROUND

Many domesticated animals or pets fall victim to the same health problems that humans encounter. Some of these problems include but are not limited to obesity, hypertension, heart disease, chronic food allergies, severe osteoarthritis, diabetes mellitus, urinary incontinence, bladder stones, chronic urinary tract infections, gastroenteritis, pancreatitis, hypothyroidism, and other endocrine disorders. Many of these issues are considered to be iatrogenic or self-inflicted and drastically affect the pet's quality of life. These issues commonly arise when pet owners get in the bad habit of feeding their domesticated pets a variety of “human food” or “table scraps.” Pet owners seldom understand the devastating effects that excessive high protein and fatty foods has on a pet's body over time. Although very similar, dog's and cat's organs and organ systems are not created equal to man, nor can they handle the wide variety of food and seasoning that humans can endure. Their sensitivity to various cooked meats and toxicities to certain food seasonings, like onion and garlic powder, often trigger a domino effect of long term health issues; many of which are considered to be life threatening even with aggressive medical therapy.

Many of these diseases could have been prevented with proper diet and nutrition. Even after a pet owner's veterinarian prescribes prescription food to now address the pet's health issues, it is very difficult for the pet owner to entice the pet to eat the prescriptive food after many years of having eaten “table food” or other unhealthy food not suitable for pets. No matter how important and necessary a prescription food is in animal health care, it is of no benefit if the pet will not eat it.

The dog's sense of smell is uniquely defined from anatomical composition on down to the cellular infrastructure. The dog's nose consists of a bony nasal cavity divided into two separate chambers by a bony and cartilaginous nasal septum. Each cavity contains turbinate bones known as conchae and paranasal sinuses that have a maze-like structure and a unique filtration system lined with ciliated epithelial cells that contain many scent receptors. The inhaled scents are trapped in mucus and processed by the sensory cells. Each cell contains 10-100 axons that send messages through the ethmoid bone directly to the olfactory bulb of the brain. Scents are then transported to the frontal cortex for recognition and stimulation of the brain's centers for emotions, memory, and pleasure. Anatomically, the dog has devoted an estimated one-third of the dog's brain tissue to olfactory cells to aid in scenting.

Current literature typically teaches us that a pet's strong olfactory bulb and unique sense of smell can be used to successfully manipulate a pet's behavior to a more desired outcome. Other literature teaches us that desired outcomes, such as dental hygiene, can also be achieved through an animal's food bowl.

United States Patent Publication No. 2009/0275670 A1, entitled “Dog Pheromone Formulation and Delivery System,” discloses a system that releases a dog-appeasing pheromone that simulates a mother dog's pheromone. This ultimately establishes a relaxing and calming effect on both young pups and adults. The present invention and pheromone formulation and delivery system are alike in that they both target the dog's sense of smell to attain a desired reaction. They are different in that the present invention is specifically useful in promoting healthy and nutritional eating habits for pets. This food delivery system will provide an aromatherapy that entices the pet's appetite and interest while ultimately encouraging the pet to eat the desired and recommended pet food.

United States Patent Publication No. 2014/0060442 A1, entitled “Animal Feeding Apparatus and Methods of Use,” describes a feeding bowl apparatus that promotes dental hygiene and methods of cleaning an animal's teeth. The apparatus is specifically designed to help clean an animal's teeth and gums as they eat from the apparatus through a plurality of protrusions that extend into the feeding well. The disclosure makes no claims or use of methods geared towards methods of appetite stimulation in pets and is solely responsible for claiming promotion of healthier dental hygiene in animals.

U.S. Pat. No. 7,895,975, entitled “Dog Food Bowl with Integral Protrusion for Preventing Aspiration of Food,” describes a food bowl apparatus containing centrally oriented protrusions that help prevent animals from inadvertent aspiration of food by overzealous eating habits. This device provides a form of intervention for pets with feeding behaviors characterized by swallowing large amounts of food but this invention does not address the issue of animal appetite stimulation and/or dietary discretion.

Many types of bowls are in common use today with wide acceptance of stainless steel and plastic configurations. Some are designed to slow a pet's eating speed during feeding sessions to help prevent choking, while some are designed with protrusions to promote better dental hygiene while a pet is eating. There are various forms of pet feeding bowls on the market that vary in function and/or fashion but none of them are formatted to increase pet appetite stimulation. This invention provides a new option to pet appetite stimulation and healthy dietary discretion.

For the reasons set forth above, there exists a need for a means to entice domesticated animals to eat nutritional meals suitable for their health needs.

### SUMMARY OF THE INVENTION

A food bowl system according to one embodiment of the present invention may include a first bowl and a perforated member. A second bowl having a bottom portion and a sidewall is releasably engageable with the first bowl and the perforated member so that the first and second bowls can be separated and joined together with the perforated member disposed between the first and second bowls. In another embodiment, the perforated member may comprise an integral portion of the first bowl, so that the perforated member defines a perforated bottom portion of the first food bowl.

Also disclosed is a food bowl system that may include first and second bowls each having a bottom portion and a side wall. The bottom portion of the first bowl defines at least one perforation therein. Fastening means operatively associated with the first and second bowls allows the first and second food bowls to be releasably engaged with one another so that they may be separated and joined together.

Another embodiment of a food bowl system may include a first bowl portion having a side wall. A second bowl having a bottom and a side wall is releasably engageable with the first bowl portion so that the first and second bowls can be separated and joined together. Ventilation means provided between the first and second bowls when they are joined together isolates animal food provided in the first bowl from aroma-producing material provided in the second bowl while allowing aromas from the aroma-producing material provided in the second bowl to migrate to the first bowl, the migrating aromas stimulating an animal to consume the animal food provided in the first bowl.

Also disclosed is a method of feeding an animal that may involve the steps of: Providing a food bowl system having a first bowl and a second bowl that is releasably engageable with the first bowl; placing an aroma-producing material in the second bowl; placing a perforated member over the aroma-producing material in the second bowl; engaging the first bowl and the second bowl so that the first and second bowls are joined together so that the perforated member is disposed therebetween; placing animal food in the first bowl; and presenting the food bowl system to an animal to be fed, wherein aromas from the material in the second bowl migrate to the first bowl through the perforated member, the migrating aromas stimulating the animal to consume the animal food provided in the first bowl.

### BRIEF DESCRIPTION OF THE DRAWINGS

Illustrative and presently preferred exemplary embodiments of the invention are shown in the drawings in which:

FIG. 1 is a perspective view of one embodiment of a food bowl system according to the present invention with the first and second bowls joined together but in the unlocked position;

FIG. 2 is a perspective view of the food bowl system of FIG. 1 with the first and second bowls and perforated member shown separated from one another;

FIG. 3 is a side view in elevation of the food bowl system illustrated in FIG. 1;

FIG. 4 is a top view of the food bowl system illustrated in FIG. 1 showing one arrangement of perforations provided in the perforated member;

FIG. 5 is a bottom view of the food bowl system illustrated in FIG. 1;

FIG. 6 is a top view of the food bowl system showing another arrangement of the perforations provided in the perforated member;

FIG. 7 is a perspective view of a second embodiment of the food bowl system wherein the perforated member comprises an integral portion of the upper bowl to form a perforated bottom portion;

FIG. 8 is an enlarged side view in elevation of one embodiment of a fastening system that may be used to secure the first and second bowls together;

FIG. 9 is an enlarged side view in elevation of a second embodiment of fastening system that may be used to secure the first and second bowls together;

FIG. 10 is an enlarged side view in elevation of a third embodiment of a fastening system that may be used to secure the first and second bowls together; and

FIG. 11 is an enlarged side view in elevation of a fourth embodiment of a fastening system that may be used to secure the first and second bowls together.

### DETAILED DESCRIPTION OF THE PREFERRED EMBODIMENTS

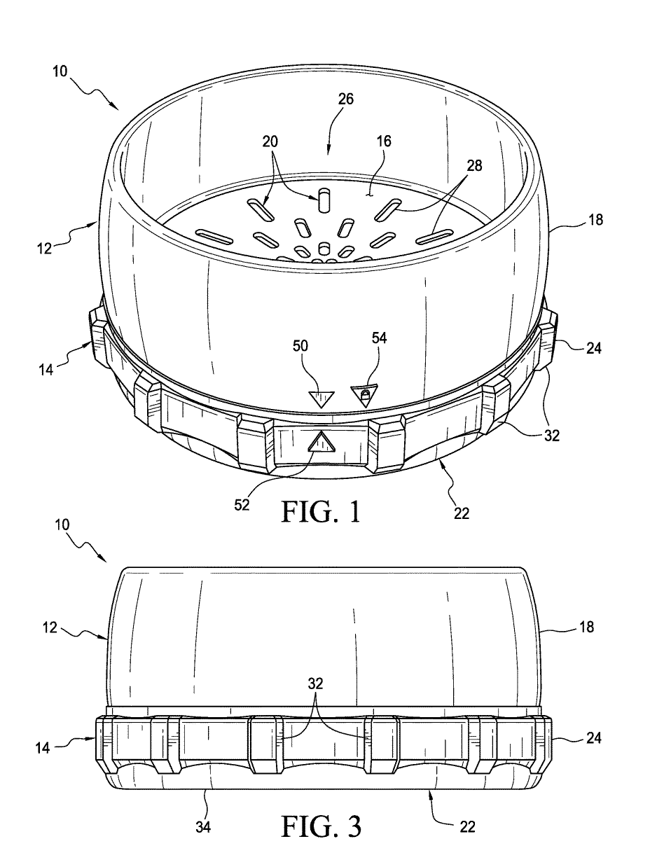

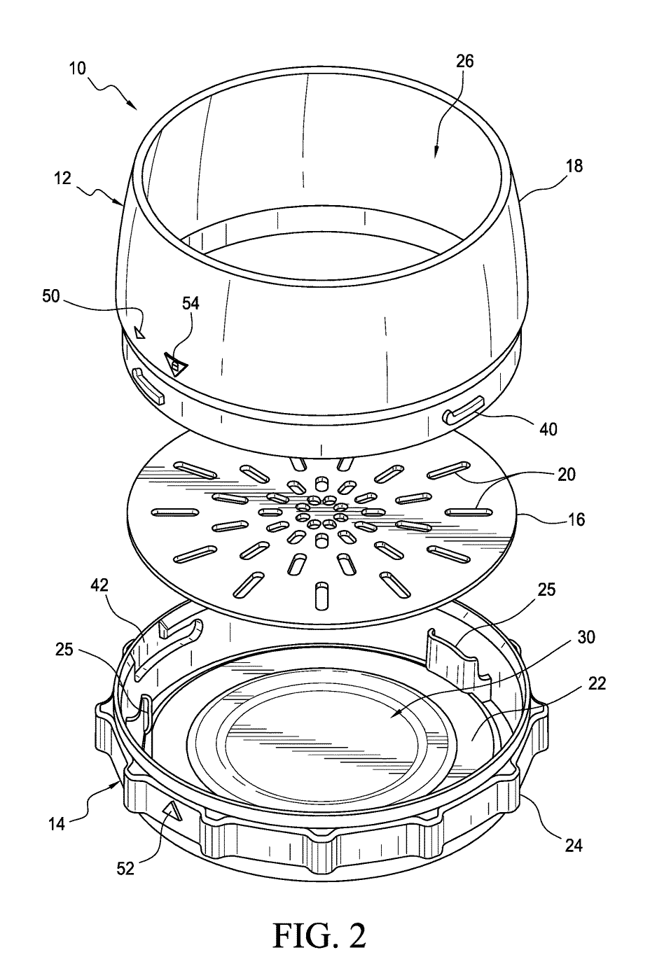

One embodiment of a food bowl system 10 according to the present invention is illustrated in FIGS. 1 and 2 and may comprise a first or upper bowl portion 12 and a second or lower bowl 14. The first or upper bowl portion 12 may comprise a generally cylindrically shaped configuration having a side wall 18. In one embodiment, the upper bowl portion 12 is sized to receive a separate perforated member 16 defining one or more perforations 20 therein. The arrangement is such that when the upper and lower bowls 12 and 14 are placed together, the upper bowl portion 12 and perforated member 16 define an interior region or cavity 26 suitable for receiving animal food. The second or lower bowl 14 may comprise a bottom 22 and a side wall 24. In an embodiment with a separate perforated member 16, lower bowl 14 may also be provided with one or more support members 25 sized to receive and support the perforated member 16, as best seen in FIG. 2. When engaged or joined together, as illustrated in FIG. 1, the upper and lower bowls 12 and 14 form the food bowl system 10. When disengaged, the upper and lower bowls 12 and 14 and perforated member 16 may be separated from one another for feeding preparation and cleaning.

To use the food bowl system 10, a user simply places in the lower bowl 14 a desired aroma-producing material, such as, for example, human food (not shown). The user would then place the perforated member 16 on the supports 25 provided in the lower bowl 14. The upper bowl portion 12 may then be engaged or attached to the lower bowl 14 so they are joined together, with the perforated member 16 disposed or positioned between the upper bowl portion 12 and lower bowl 14. The desired animal food (also not shown) then may be placed in the cavity 26 (e.g., defined by the side wall 18 of upper food bowl portion 12 and the perforated member 16) for consumption by an animal, such as a dog or a cat. The perforations 20 provided in the perforated member 16 isolate the aroma-producing material provided in the lower bowl 14 from the animal food provided in the upper bowl 12. However, the perforations 20 allow aromas from the material in the lower bowl 14 to migrate to the upper bowl 12, thereby motivating the animal to consume the food in the upper bowl 12 while at the same time preventing the animal from consuming the material provided in the lower bowl 14.

A significant advantage of the food bowl system 10 of the present invention is that it releases various aromatherapy fragrances that may be consistent with the same human foods that pet owners feed their pets on a routine basis. Indeed, in many instances, the aroma-producing material used to provide the aromatherapy may comprise human food. The system 10 allows aromas from aroma-producing material placed in the lower bowl 14 to migrate to the upper bowl 12 that contains the desired animal food. The aromas from the material in the lower bowl 14 trigger the pet's olfactory bulb and brain centers for emotions, memory, and appetite stimulation thereby enticing the animal to consume the animal food provided in the upper bowl 12 while preventing the animal from consuming the aroma-producing material in the lower bowl 14, which might otherwise be unhealthful for the animal or otherwise compromise the animal's quality of life. In addition, the fastening system allows the upper and lower bowls to be readily separated from one another for food preparation and cleaning.

Having briefly described one embodiment of the food bowl system 10 according to the teachings of the present invention, along with some of its more significant features and advantages, various embodiments and alternative configurations of the food bowl system will now be described in detail. However, it should be noted that while the following description is directed to various embodiments and alternative structures and methods, other variations and modifications of the food bowl system and method of feeding animals will become apparent to persons having ordinary skill in the art after having become familiar with the teachings provided herein. Therefore, the present invention should not be regarded as limited to the particular structural arrangements, configurations, materials, and methods shown and described herein.

Referring now primarily to FIGS. 1-4, a first embodiment of the food bowl system 10 may comprise a first or upper bowl portion 12 and a second or lower bowl 14, and a perforated member 16. The upper bowl portion 12 may comprise a side wall 18 that is sized to receive perforated member 16 so that together they define the interior region or cavity 26 suitable for receiving a desired quantity of animal or pet food (not shown). In the particular embodiment shown and described herein, the side wall 18 comprises a generally cylindrically-shaped member, as best seen in FIGS. 1 and 2. Alternatively, the side wall 18 could comprise other sizes, shapes, and configurations that would be suitable for the particular application and type of animal to be fed. Consequently, the present invention should not be regarded as limited to a side wall 18 having any particular size, shape, or configuration.

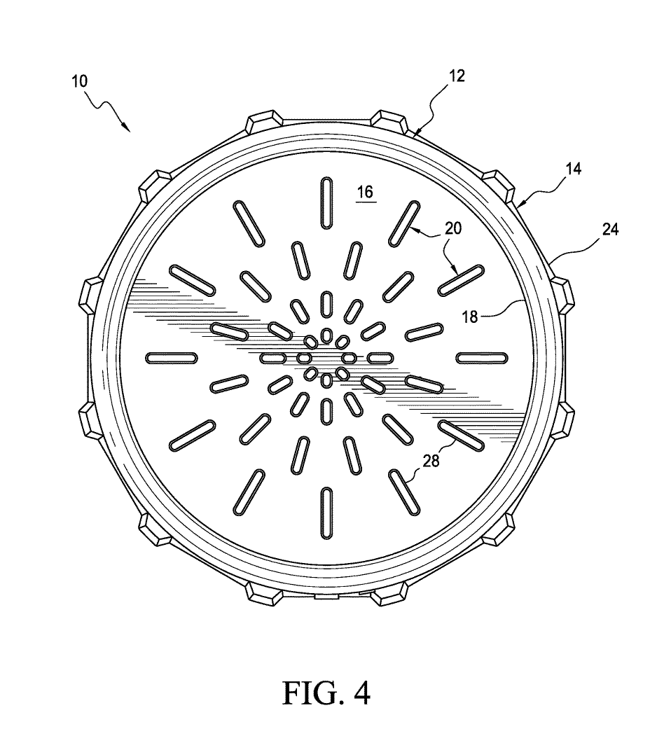

The perforated member 16 may comprise a generally flat, disc-shaped member that closes off the bottom portion of side wall 18 of upper food bowl portion 12, thereby defining the interior cavity 26. The perforated member 16 may also define one or more perforations or holes 20 therein that are sized to allow aromas from material provided in the lower bowl 14 to migrate to the interior cavity 26 of upper bowl 12, yet isolate the material provided in the lower bowl 14 so that it cannot be eaten or consumed by the animal or pet feeding from the upper bowl 12. In one embodiment, the perforations 20 may comprise elongate, slit-like openings 28 arranged in a radial configuration, as best seen in FIG. 4.

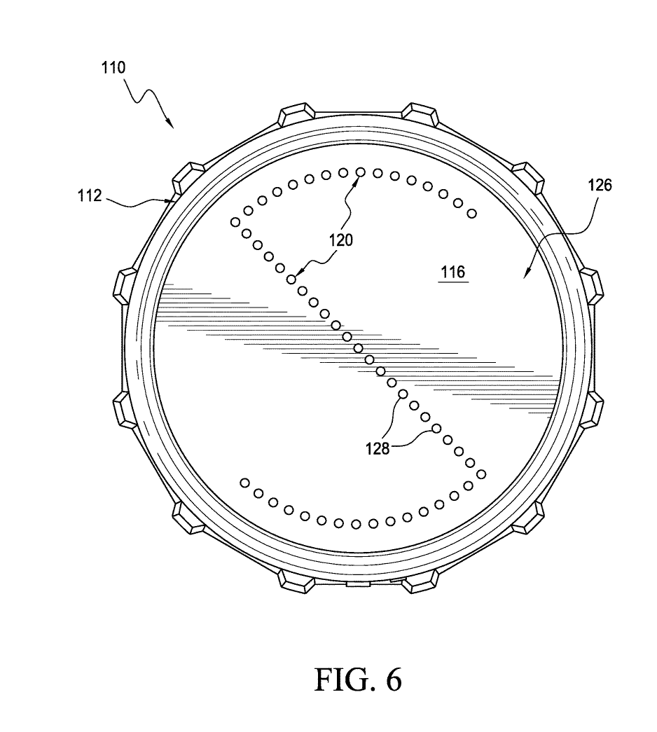

Alternatively, other configurations of the perforations are possible. For example, in another embodiment 110, illustrated in FIG. 6, perforations 120 defined by perforated member 116 may comprise circular openings 128 arranged to form an S-shape. Still other alternatives are possible, as would become apparent to persons having ordinary skill in the art after having become familiar with the teachings provided herein. Consequently, the present invention should not be regarded as limited to any particular type or configurations of the perforations 20, 120.

The perforations 20, 120 provided in perforated members 16, 116 may comprise any of a range of sizes suitable for isolating the materials provided in the upper and lower bowls 12, 112, and 14, 114, yet allowing aromas from the material in the lower bowl 14, 114 to migrate to the interior region 26, 126 of the upper bowl 12, 112. Consequently, the present invention should not be regarded as limited to perforations having any particular size or configuration. However, by way of example, in one embodiment, perforations may have widths (i.e., in the case of slits 28) or diameters (i.e., in the case of holes 128) ranging from about 1.5 mm to about 2 mm. The perforations 20, 120 may be spaced apart from one another by distance in a range of about 4 mm to about 5 mm, although other spacings may be used, again based on the particular application and type of animal to be fed.

Regardless of the particular shape and configurations of the perforations 20, 120 that may be provided, the perforations 20 and 120 may be regarded as a ventilation system or means for allowing aromas from material placed in the lower bowl 14, 114 to migrate to the upper bowl 12, 112, while also isolating or preventing access to the material in the lower bowl 14, 114.

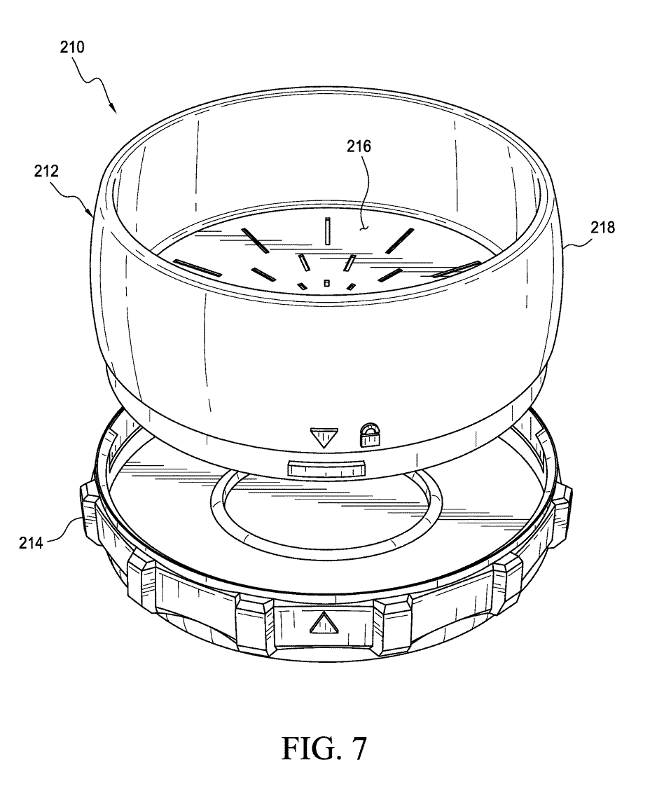

As mentioned, the upper bowl portion 12 and perforated member 16 may comprise two separate pieces that are sized and configured to be joined together, so that they define the upper food bowl 12. However, other arrangements are possible. For example, in another embodiment 210 illustrated in FIG. 7, perforated member 216 may comprise an integral portion of upper bowl 212, defining a perforated bottom portion 216 of upper bowl 212. The upper bowl 212 may be releasably engageable with a lower bowl 214 in accordance with the teachings provided herein.

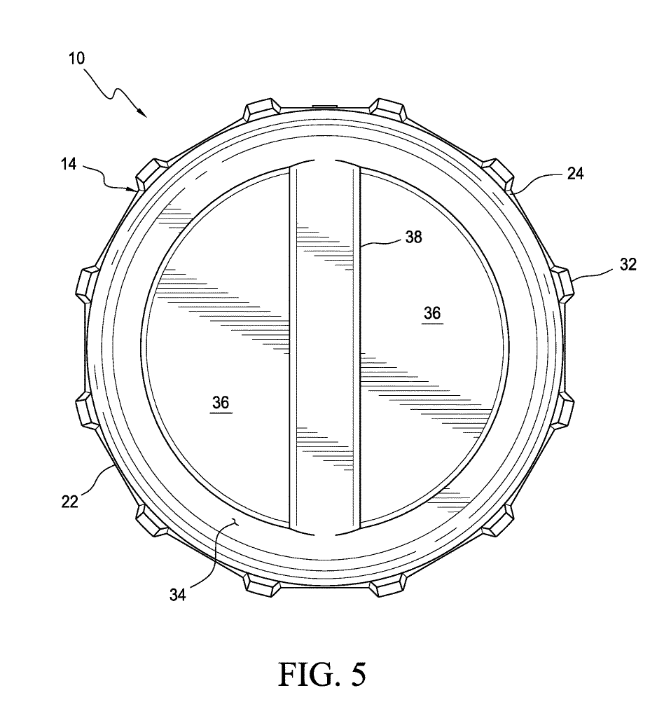

Referring back now primarily to FIGS. 2 and 5, the lower bowl 14 may comprise a bottom 22 and a side wall 24 that together define an interior region or cavity 30 therein that is sized to receive a desired quantity of the aroma-producing material (not shown). In an embodiment with a separate perforated member 16, lower bowl 14 may also be provided with one or more support members 25 sized to receive and support the separate perforated member 16.

In the particular embodiment shown and described herein, the side wall 24 of lower bowl 14 may comprise a generally cylindrically-shaped member and may be provided with one or more protrusions or grips 32 thereon to allow a user to more easily handle the food bowl system 10 and engage and disengage the lower bowl 14 from the upper bowl 12. As was the case for the upper bowl 12, side wall 24 of lower bowl 14 may comprise other shapes or configurations, depending on the particular application, animal to be fed, and various aesthetic considerations. Such alternative configurations or designs for side wall 24 may also include grips identical to grips 32 shown and described herein, or such grips may have different shapes or configurations. Of course, the side wall 24 of lower bowl 14 could also be devoid of any external surface features or ornamentation. In any event, the present invention should not be regarded as limited to bowls 12 and 14 having side walls 18 and 24 of any particular size, shape, or configuration.

The bottom 22 of lower bowl 14 may comprise a generally flat, disc-shaped member that closes off the bottom portion of side wall 24, thereby defining the interior cavity 30 of lower bowl 14. The underside 34 of bottom 22 may be provided with opposed depressions 36 that together define a grip 38, as best seen in FIG. 5. In some embodiments, grip 38 may assist a user in rotating the upper and lower bowls 12 and 14 with respect to one another to engage and disengage the upper and lower bowls 12 and 14. The bottom portion 22 of lower bowl 14 may comprise an integral portion of lower bowl 14 or may comprise a separate element.

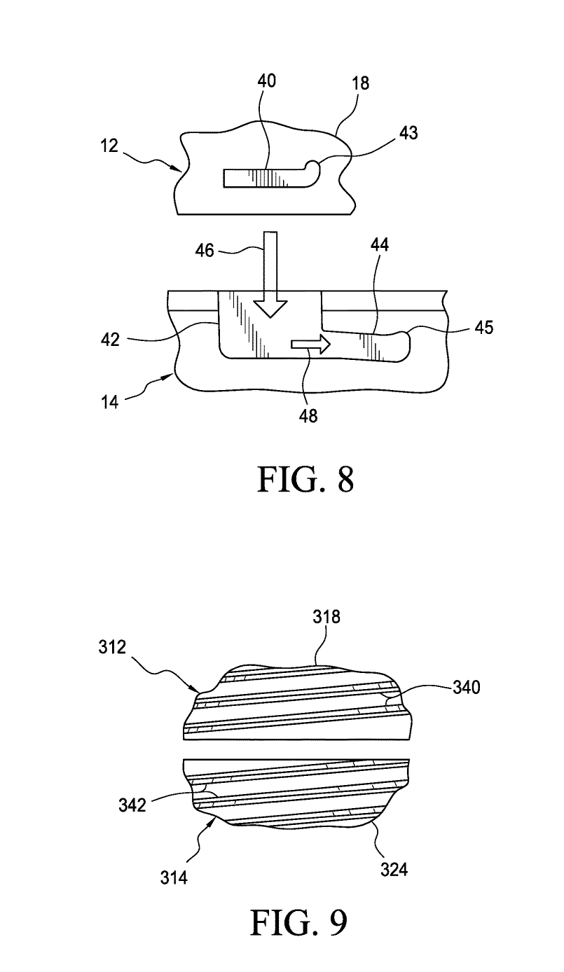

As mentioned earlier, the upper and lower bowls 12 and 14 and bottom member 16 may be releasably engageable with one another so that they can be joined together and separated to facilitate cleaning and the addition of the aroma-producing material provided in the lower bowl 14. Any of a wide variety of fastening devices or systems may be used to allow the upper and lower bowls 12 and 14 to be releasably engaged with one another. For example, and with reference now to FIGS. 2 and 8, in one embodiment, the side wall 18 of upper bowl 12 may be provided with one or more elongated lugs 40 that are sized to be received by corresponding slots 42 provided on the side wall 24 of lower bowl 14. Each slot 42 may be provided with a step 44 therein so that when the upper and lower bowls 12 and 14 are moved together (i.e., in the direction of arrow 46), the lug 40 will be received by slot 42. Each lug 40 may be provided with a raised boss 43 sized to be received by a corresponding detent 45 provided in each slot 42. Thereafter, the upper and lower bowls 12 and 14 may be rotated with respect to one another (i.e., in the direction of arrow 48) which will cause lug 40 to be captured by step 44, thereby locking or engaging the bowls 12 and 14 together. The engagement of the raised bosses 43 on lugs 40 with the detents 45 in slots 42 securely hold the bowls 12 and 14 in the locked position.

In one embodiment, the side walls 18 and 24 of upper and lower bowls 12 and 14 may be provided with suitable indicia, such as arrows 50 and 52 and a lock symbol 54 to indicate when the upper and lower bowls 12 and 14 are in the unlocked and locked positions. See FIG. 1. For example, when the arrows 50 and 52 are aligned, the bowls 12 and 14 are joined together, but not locked. Thereafter, the bowls 12 and 14 can be locked together by rotating them with respect to one another so that arrow 52 is aligned with the lock symbol 54.

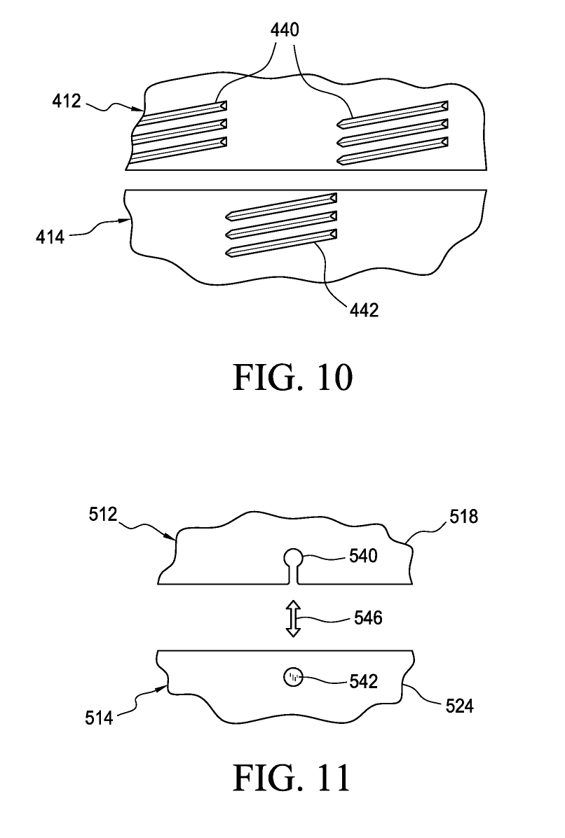

Still other types of fastening systems are possible and may be used to allow the upper and lower bowls 12 and 14 to be releasably engaged with one another. For example, and with reference now to FIG. 9, in another embodiment, the fastening system may comprise screw threads 340 and 342 provided on the side walls 318 and 324 of upper and lower bowls 312, 314, respectively. The screw threads 340 and 342 allow the upper and lower bowls 312 and 314 to be engaged and disengaged from one another by screwing them together or by unscrewing them. The threads 340 and 342 may comprise continuous single lead threads. Alternatively, the threads may comprise multiple-lead threads, such as double- or triple-lead threads. The use of multiple-lead threads will allow the bowls 312 and 314 to be rapidly engaged and disengaged from one another with a reduced number of turns compared to single-lead threads. In yet another embodiment, illustrated in FIG. 10, the threaded arrangement may comprise interrupted or sectored threads 440 and 442 in which a number of threaded sectors are provided in each bowl 412, 414. Depending on the number of sectors used, the threaded areas may be fully engaged or disengaged by rotation of the bowls 412, 414 through only a small part of one turn.

Still other fastening systems may be used to releasably engage the first and second bowls. For example, in another embodiment shown in FIG. 11, the sidewall 518 of the upper bowl 512 may be provided with one or more slots 540 sized to engage a corresponding number of pins 542 provided on side wall 524 of lower bowl 514. The bowls can then be joined and released by simply urging them together and prying them apart, i.e., in the directions indicated by arrows 546. Still other fastening systems and arrangements are possible, as would become apparent to persons having ordinary skill in the art after having become familiar with the teachings provided herein. Consequently, the present invention should not be regarded as limited to any particular arrangement for releasably engaging the bowls.

The upper and lower bowls 12 and 14 and separate bottom member 16 may be fabricated from any of a wide range of materials, such as metals, ceramics, or plastics that are now known in the art or that may be developed in the future that are or would be suitable for the particular application. Consequently, the present invention should not be regarded as limited to any particular material. However, by way of example, in one embodiment, the upper and lower bowls 12 and 14 and separate bottom member 16 are fabricated from a thermoplastic material, such as ABS or PVC plastic. Optionally, a rubber base layer or ring (not shown) may be placed on the bottom 22 of lower bowl 14 for increased traction and to reduce the tendency of the bowl system 10 to slide on the floor.

The bowl system 10 of the present may be used as follows to initiate a feeding session for an animal. A suitable aroma-producing material or human food, such as hamburger, bacon, beef, or chicken may be placed in the interior region 30 of lower bowl 14. If desired, the material may be heated prior to placing in lower bowl 14 to enhance the stimulative effect of the aroma produced thereby. Alternatively, specialized aromatherapy materials or fragrances are known and can be used in place of human food. The perforated member 16 may then be placed over the aroma-producing material provided in the lower bowl 14. The upper and lower bowls 12 and 14 may then be secured together. Thereafter, the desired animal food may then be placed in the interior region 26 defined by the perforated member 16 and side wall 18 of upper bowl portion 12. The food bowl system 10 may then be presented to the animal or pet for feeding.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The following Examples were all conducted on Pet A, a 7 year old, healthy, 65 pound mixed breed dog that had been eating Hill's Science Diet, adult grain free, salmon and rice for several months prior to conducting the experiments set forth in the examples below:

### Example 1

### Control

Pet A was fed one cup of Hill's Science Diet, adult grain free, salmon and rice twice a day over a period of 5 days in a traditional stainless steel, single dog bowl. All feedings took place indoors with no distractions. The times required for Pet A to consume the food during morning (am) and afternoon (pm) feeding sessions are listed in Table I.

TABLE I

| Day 1 | Day 2 | Day 3 | Day 4 | Day 5 |
|---|---|---|---|---|
| (am/pm) | (am/pm) | (am/pm) | (am/pm) | (am/pm) |
| 3 h/2 h. | 1 h. | 5 h. | 4 h. | 1 h. |
| 30 m | 40 m/45 m | 20 m/1 h | 25 m/1 h. 20 m | 40 m/3 h |

### Example 2

Pet A was fed one cup of Hill's Science Diet, adult grain free, salmon and rice twice a day over a period of 5 days in the food bowl system 10 of the present invention. All feedings took place indoors with no distractions. 1 cup of dry food was placed in upper bowl 12 and well-seasoned grilled steak pieces were placed in lower bowl 14. The steak pieces were reheated to maximize the aromatherapy prior to placing them into lower bowl 14. The upper and lower bowls 12 and 14 were then joined together and offered to Pet A for consumption. The times required for Pet A to consume the food during morning (am) and afternoon (pm) feeding sessions are listed in Table II.

TABLE II

| Day 1 | Day 2 | Day 3 | Day 4 | Day 5 |
|---|---|---|---|---|
| (am/pm) | (am/pm) | (am/pm) | (am/pm) | (am/pm) |
| 3 m/5 m | 2 m/3 m | 3 m/4 m | 5 m/3 m | 5 m/3 m |

Having herein set forth preferred embodiments of the present invention, it is anticipated that suitable modifications can be made thereto which will nonetheless remain within the scope of the invention. The invention shall therefore only be construed in accordance with the following claims:

1. A food bowl system, comprising:
a first bowl comprising a side wall
a perforated member; and
a second bowl comprising a bottom portion and a sidewall, said second bowl being releasably engageable with said first bowl and said perforated member so that said first and second bowls can be separated and joined together, said perforated member separating said first and second bowls when said first and second food bowls are joined together.

2. The food bowl system of claim 1, further comprising a lug provided on the side wall of said first bowl and a slot provided on the side wall of said second bowl.

3. The food bowl system of claim 2, wherein said slot comprises a stepped slot sized to releasably receive said lug when said first bowl is in an unlocked position and capture said lug when said first bowl is rotated to a locked position with respect to said second bowl.

4. The food bowl system of claim 1, further comprising screw threads provided on an outer portion of the side wall of said first bowl and mating screw threads provided on an inner portion of the side wall of said second bowl so that said first and second bowls can be screwed together.

5. The food bowl system of claim 4, wherein the screw threads provided on the first and second bowls comprise single-lead threads.

6. The food bowl system of claim 4, wherein the screw threads provided on the first and second bowls comprise multi-lead threads.

7. The food bowl system of claim 4, wherein the screw threads provided on the first and second bowls comprise interrupted threads.

8. The food bowl system of claim 1, wherein said first and second bowls are formed from a thermoplastic material.

9. The food bowl system of claim 8, wherein said thermoplastic material comprises one or more selected from the group of ABS plastic and PVC plastic.

10. The food bowl system of claim 1, wherein said first and second bowls are formed from metal.

11. The food bowl system of claim 10, wherein said metal comprises stainless steel.

12. A food bowl system, comprising:
a first bowl comprising a bottom portion and a side wall, the bottom portion of said first bowl defining at least one perforation therein;
a second bowl comprising a bottom portion and a sidewall; and
fastening means operatively associated with said first and second bowls for releasably engaging said first and second bowls so that said first and second bowls can be separated and joined together.

13. The food bowl system of claim 12, wherein said fastening means comprises a lug provided on the first bowl and a slot provided on the second bowl.

14. The food bowl system of claim 13, wherein said slot comprises a stepped slot sized to receive said lug when said first bowl is in an unlocked position and capture said lug when said first bowl is rotated to a locked position.

15. The food bowl system of claim 12, wherein said fastening means comprises screw threads provided on said first and second bowls.

16. The food bowl system of claim 12, wherein said fastening means comprises at least one slot provided on the first bowl and at least one pin provided on the lower bowl, the slot and pin being sized to releasably engage one another to allow the first and second bowls to be separated and joined together.

17. A food bowl system, comprising:
a first bowl portion comprising a side wall;
a second bowl comprising a bottom and a sidewall, said second bowl being releasably engageable with said first bowl so that said first and second bowls can be separated and joined together; and
ventilation means provided between said first and second bowls when said first and second bowls are joined together said ventilation means isolating animal food provided in said first bowl from aroma-producing material provided in said second bowl while allowing aromas from the aroma-producing material provided in said second bowl to migrate to said first bowl, the migrating aromas stimulating an animal to consume the animal food provided in the first bowl.

18. The food bowl system of claim 17, wherein said ventilation means comprises a perforated member.

19. The food bowl system of claim 18, wherein said perforated member is integral with said first bowl, so that said perforated member forms a bottom of said first bowl.

20. A method of feeding an animal, comprising:
providing a food bowl system comprising a first bowl, a perforated member, and a second bowl, the first and second bowls being releasably engageable with one another;
placing an aroma-producing material in the second bowl;
positioning the perforated member on the second bowl;
engaging the first bowl and the second bowl so that the first and second bowls are joined together with the perforated member positioned therebetween;
placing animal food in the first bowl; and
presenting the food bowl system to an animal to be fed, aromas from the material in the second bowl migrating to the first bowl through the perforated member, the migrating aromas stimulating the animal to consume the animal food provided in the first bowl.

21. A method of feeding an animal, comprising:
providing a food bowl system comprising a first bowl having a perforated bottom and a second bowl that is releasably engageable with the first bowl;
placing an aroma-producing material in the second bowl;
engaging the first bowl and the second bowl so that the first and second bowls are joined together;
placing animal food in the first bowl; and
presenting the food bowl system to an animal to be fed, aromas from the material in the second bowl migrating to the first bowl through the perforated bottom of the first bowl, the migrating aromas stimulating the animal to consume the animal food provided in the first bowl.
